(19) United States
(12) Patent Application Publication
(10) Pub. No.: US 2026/0139534 A1
(43) Pub. Date: May 21, 2026

(54) ROTATION LIMITER FOR SHOWER DOOR ASSEMBLY

(71) Applicant: KOHLER CO., Kohler, WI (US)

(72) Inventor: Mark Andrew LISTER, Martin, TN (US)

(73) Assignee: KOHLER CO., Kohler, WI (US)

(21) Appl. No.: 19/392,751

(22) Filed: Nov. 18, 2025

Related U.S. Application Data
(60) Provisional application No. 63/722,702, filed on Nov. 20, 2024.

(51) Int. Cl. E05F 5/06

(52) U.S. Cl. CPC E05F 5/06; E05Y 2600/10; E05Y 2600/46; E05Y 2900/114

(57) ABSTRACT

A hinge assembly for a shower door includes a body including a pocket. The hinge assembly includes a hinge clamp rotatably coupled to the body. The hinge clamp is configured to receive a portion of the shower door. The hinge assembly includes a rotation limiter movably disposed in the pocket. The rotation limiter is configured to move relative to the pocket based on a rotational position of the hinge clamp relative to the body.

### CROSS-REFERENCE TO RELATED PATENT APPLICATIONS

This application claims the benefit of and priority to U.S. Provisional Application No. 63/722,702, filed November 20, 2024, the entire disclosure of which is hereby incorporated by reference herein.

### BACKGROUND

The present disclosure relates generally to a hinge assembly for a shower door. More specifically, the present disclosure relates to a hinge assembly for a shower door that includes a rotation limiter for limiting over-rotation of the door in one direction.

In some instances, pivoting shower doors, such as overlapping glass doors, can experience glass-to-glass contact when over-rotated. Thus, it would be advantageous to provide a hinge assembly for a shower door that addresses one or more of the aforementioned issues.

### SUMMARY

At least one aspect of the present disclosure relates to a hinge assembly for a shower door. The hinge assembly includes a body including a pocket. The hinge assembly includes a hinge clamp rotatably coupled to the body. The hinge clamp is configured to receive a portion of the shower door. The hinge assembly includes a rotation limiter movably disposed in the pocket. The rotation limiter is configured to move relative to the pocket based on a rotational position of the hinge clamp relative to the body.

At least one aspect of the present disclosure relates to a shower door system. The shower door system includes a door and a hinge assembly configured to rotatably couple the door to a door frame. The hinge assembly includes a body coupled to the door frame. The body includes a pocket. The hinge assembly includes a hinge clamp rotatably coupled to the body. The hinge clamp is configured to receive a portion of the door. The hinge assembly includes a rotation limiter movably disposed in the pocket. The rotation limiter is configured to move relative to the pocket based on a rotational position of the hinge clamp relative to the body.

At least one aspect of the present disclosure relates to a shower door system. The shower door system includes a first door fixed to a door frame and a second door rotatably coupled to the door frame by a hinge assembly. The hinge assembly includes a body coupled to the door frame. The body includes a pocket. The hinge assembly includes a hinge clamp rotatably coupled to the body. The hinge clamp is configured to receive a portion of the second door. The hinge assembly includes a rotation limiter movably disposed in the pocket. In a first rotational position of the second door, the rotation limiter is configured to move relative to the pocket to prevent the second door from rotating in a first direction and, in a second rotational position of the second door, the rotation limiter is configured to move relative to the pocket to allow the second door to rotate in the first direction.

At least one aspect of the present disclosure relates to a hinge assembly for a shower door. The hinge assembly includes a mount body having at least one pocket to hold a rotation limiter. The hinge assembly includes a hinge clamp rotatably coupled to the mount body. The rotation limiter can extend out of and retract into the mount body based on a rotational position of the hinge clamp to selectively allow rotation of the hinge clamp relative to the mount body. The rotation limiter may include a one-way cam that can prevent open-direction rotation at a certain opening width or angle, but allow closed-direction rotation of the door. The rotation limiter can be substantially concealed when the door is fully closed.

### BRIEF DESCRIPTION OF THE DRAWINGS

FIG. 1 is a front view of a shower door system, according to an exemplary embodiment.

FIG. 2 is a perspective view of a hinge assembly of the shower door system FIG. 1, according to an exemplary embodiment.

FIG. 3 is a top view of the hinge assembly of FIG. 2, according to an exemplary embodiment.

FIG. 4 is a side perspective view of a rotation limiter of the hinge assembly of FIG. 2, according to an exemplary embodiment.

FIG. 5 is a front perspective view of the rotation limiter of FIG. 4, according to an exemplary embodiment.

FIG. 6 is an exploded view of the rotation limiter of FIG. 4, according to an exemplary embodiment.

FIG. 7A is a front perspective view of the hinge assembly of FIG. 2 in a first state, according to an exemplary embodiment.

FIG. 7B is a front perspective sectional view of the hinge assembly of FIG. 2 in the first state, according to an exemplary embodiment.

FIG. 8A is a front perspective view of the hinge assembly of FIG. 2 in a second state, according to an exemplary embodiment.

FIG. 8B is a front perspective sectional view of the hinge assembly of FIG. 2 in the second state, according to an exemplary embodiment.

FIG. 9A is a front perspective view of the hinge assembly of FIG. 2 in a third state, according to an exemplary embodiment.

FIG. 9B is a front perspective sectional view of the hinge assembly of FIG. 2 in the third state, according to an exemplary embodiment.

FIG. 10A is a front perspective view of the hinge assembly of FIG. 2 in a fourth state, according to an exemplary embodiment.

FIG. 10B is a front perspective sectional view of the hinge assembly of FIG. 2 in the fourth state, according to an exemplary embodiment.

FIG. 11A is a front perspective view of the hinge assembly of FIG. 2 in a fifth state, according to an exemplary embodiment.

FIG. 11B is a side perspective sectional view of the hinge assembly of FIG. 2 in the fifth state, according to an exemplary embodiment.

FIG. 11C is a rear perspective view of the hinge assembly of FIG. 2 in the fifth state, according to an exemplary embodiment.

FIG. 12A is a front perspective view of the hinge assembly of FIG. 2 in a sixth state, according to an exemplary embodiment.

FIG. 12B is a side perspective sectional view of the hinge assembly of FIG. 2 in the sixth state, according to an exemplary embodiment.

### DETAILED DESCRIPTION

Referring generally to the FIGURES, disclosed herein is a hinge assembly for a pivoting shower door (e.g., for an overlapping pivot shower door with two or more glass panels). The hinge assembly can include a hinge mounting body configured to rotatably couple a shower panel door to a shower door system. The hinge assembly can include a rotation limiter at least partially disposed within the hinge mounting body. The rotation limiter can extend out of and/or retract into a portion of the hinge mounting body based on a rotation state of the hinge assembly. For example, when the shower panel door is in a closed state, the rotation limiter can be disposed substantially within the hinge mounting body. As the shower panel door rotates from a closed state to an open state, the rotation limiter can move out of position to extend beyond a portion of the hinge assembly. When the shower panel door reaches a maximum open state, the rotation limiter can extend out of the hinge mounting body to prevent further rotation of the shower panel door. When the shower panel door begins to close, the rotation limiter can retract within the hinge mounting body to substantially conceal the rotation limiter.

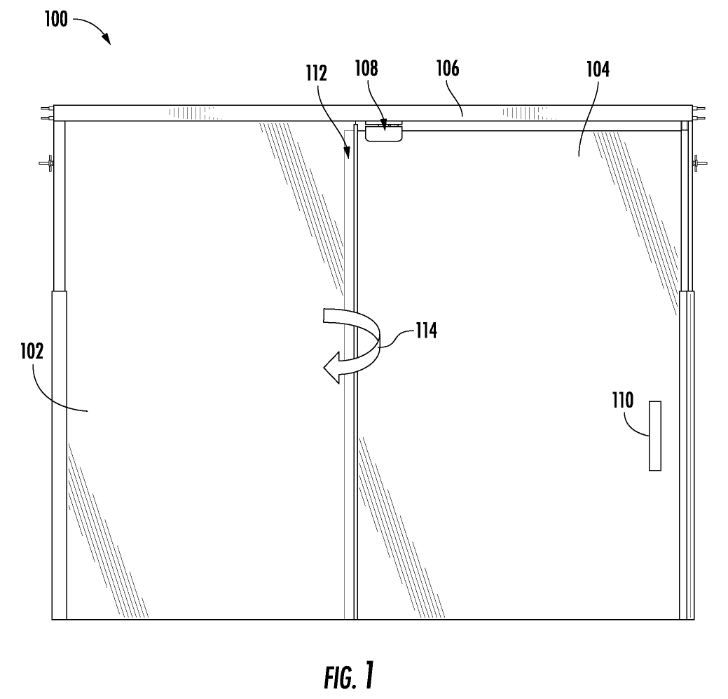

FIG. 1 depicts a front perspective view of a shower door system 100, according to an example implementation. The shower door system 100 can include a first door 102, a second door 104, a door hinge assembly 108 configured to rotatably mount at least one of the first door 102 or the second door 104 to a door mount 106 or other portion of a door frame, and/or a door handle 110. The first door 102 can include a moveable door, or the first door 102 may be a stationary panel disposed adjacent to the second door 104. The shower door system 100 can be or include an overlapping pivot door system. For example, at least a portion of the first shower door 102 and the second shower door 104 can overlap (e.g., at the overlapping portion 112). At least one of the shower doors (e.g., the second door 104) can rotate between an open and closed position. For example, the second shower door 104 can pivot in the direction of arrow 114 (in a direction away from the page) by way of the hinge assembly 108. While the hinge assembly 108 is shown coupled to a left-hand side of the second door 104, the hinge assembly 108 can be coupled to the right-hand side of the door 104 to allow the door 104 to rotate in the opposite direction.

In some implementations, the shower door system 100 can be configured such that the second door 104 can only open in one direction. At least one of the first shower door 102 or the second shower door 104 can be made of glass. In some implementations, the second shower door 104 may not include the handle 110, or the handle 110 may be positioned in a different location than shown.

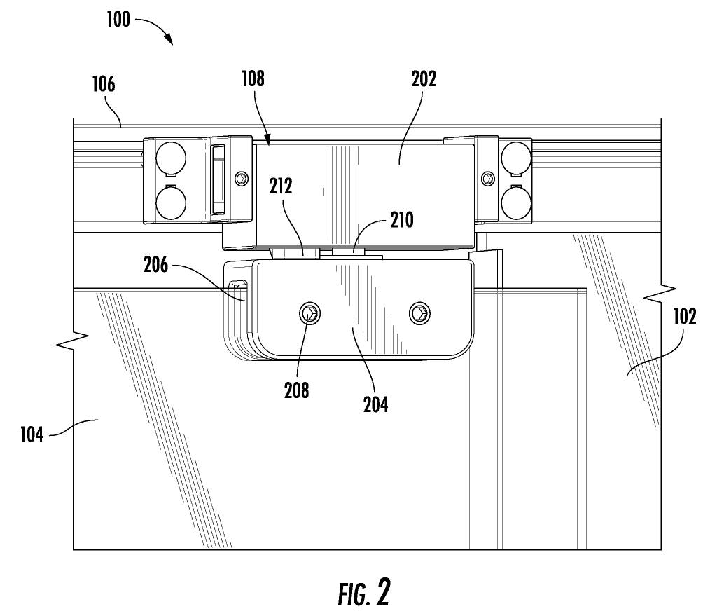

FIG. 2 depicts a rear perspective view of the hinge assembly 108 of the shower door system 100, according to an example implementation. The door hinge assembly 108 can include a hinge mount body 202 that is configured to couple to the door mount 106 (e.g., a frame, header, rod, panel, etc.) to mount the second shower door 104 to the shower door system 100. For example, the hinge mount body 202 can couple to the door mount 106 by one or more fasteners, or by various other components.

The hinge assembly 108 can include a hinge clamp 204 rotatably coupled to the hinge mount body 202. For example, the hinge mount body 202 can rotatably couple to the hinge clamp 204 by a hinge axle and/or bearing 210 that allows rotation of the hinge clamp 204 relative to the hinge mount body 202. The hinge clamp 204 can include at least one slot 206 that receives a portion of the second door 104. For example, the slot 206 can receive an edge of the door 104 and can fix the door 104 to the hinge clamp 204 by one or more fasteners 208 or other components. With this configuration, the second door 104 can rotate relative to the hinge mount body 202 and the door mount 106 to open and/or close the door 104.

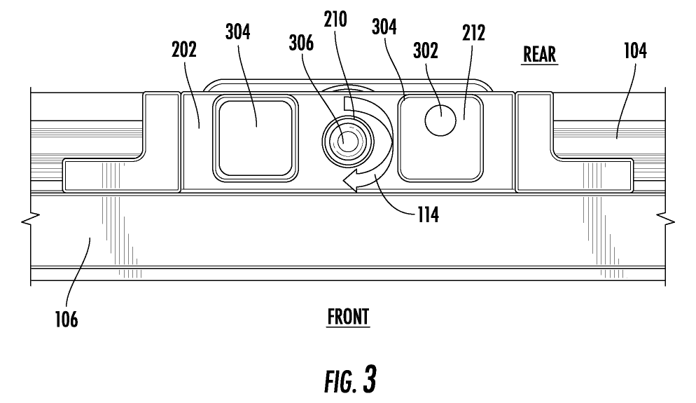

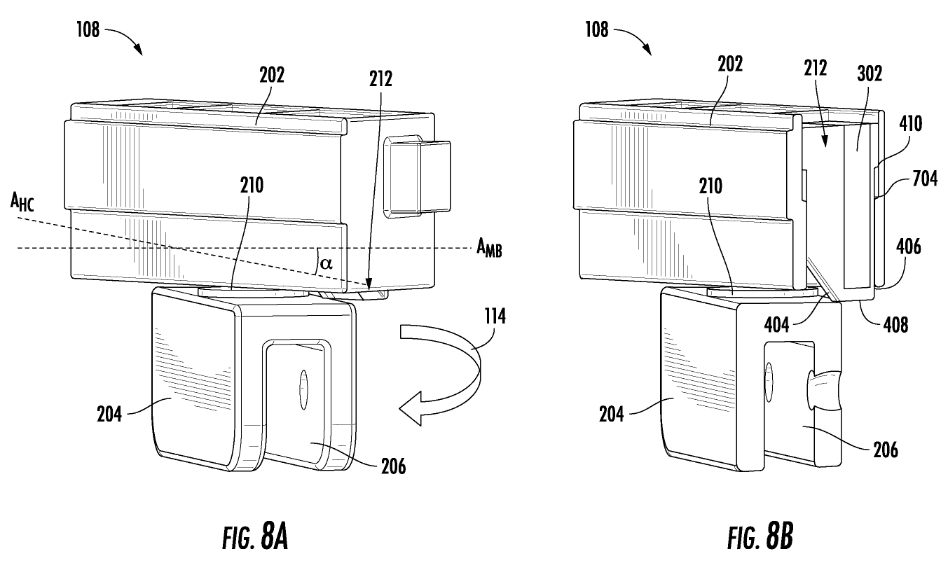

FIG. 3 depicts a top view of the hinge assembly 108 of the shower door system 100, according to an example implementation. Referring to FIGS. 2 and 3, the hinge assembly 108 can include at least one rotation limiter 212 capable of preventing the door 104 from over-rotating relative to the hinge mount body 202 and/or the first door 102. For example, the hinge mount body 202 can include at least one pocket 304 configured to receive and/or store the rotation limiter 212. The pocket 304 can include a through hole that extends through the entire hinge mount body 202 such that the rotation limiter 212 can freely move into and/or out of the pocket 304, as described herein. For example, the rotation limiter 212 can be movably disposed in the pocket 304. The pocket 304 can include at least one stopper (stopper 704, FIG. 7B) to prevent the rotation limiter 212 from falling completely out of the pocket 304.

The hinge mount body 202 can include a first pocket 304 disposed on a left-hand side of a center of rotation 306 (e.g., defined by the axle and/or bearing 210) and the hinge mount body 202 can include a second pocket 304 disposed on a right-hand side of the center of rotation 306 of the hinge assembly 108. Each of the pockets 304 can be substantially the same size and/or shape to receive the rotation limiter 212. As described in greater detail herein, one of the pockets 304 can receive the rotation limiter 212 based on a direction the door 104 rotates to open and close, such that the rotation limiter 212 is spaced away from the center of rotation 306. In other words, the rotation limiter 212 can be placed in either pocket 304 of the hinge mount body 202 to allow it to limit left or right rotation depending on the orientation of the door 104.

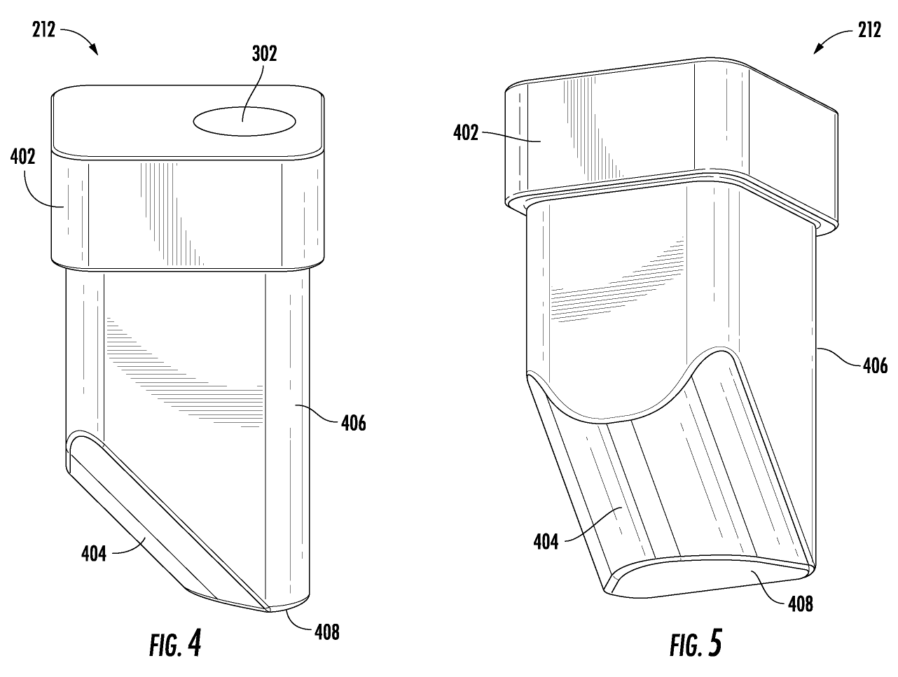

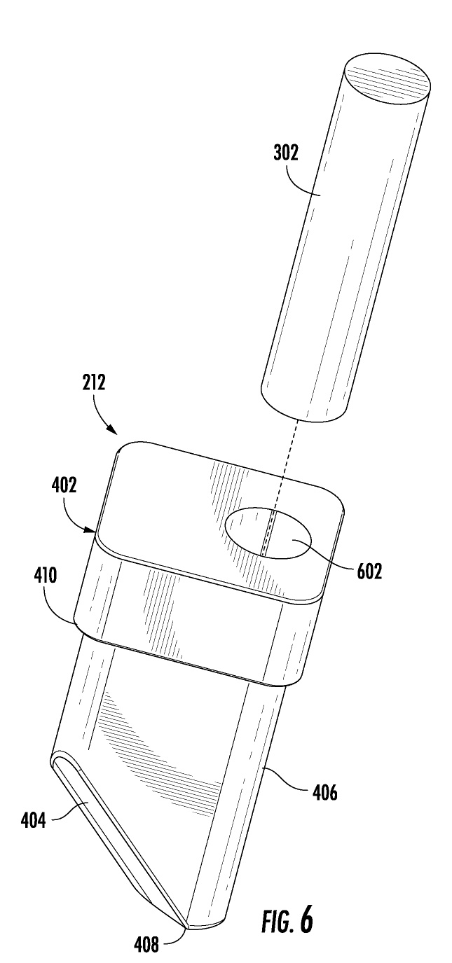

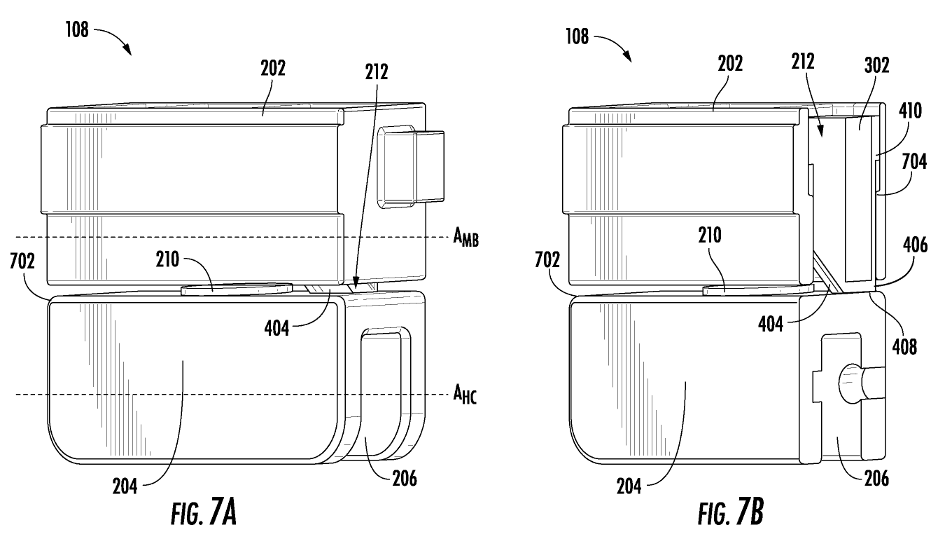

FIG. 4 is a side perspective view of the rotation limiter 212, according to an example implementation. FIG. 5 is a front perspective view of the rotation limiter 212, according to an example implementation. FIG. 6 is an exploded perspective view of the rotation limiter 212, according to an example implementation. Referring to FIGS. 4-6, the rotation limiter 212 can include a one-way cam 402 (e.g., a cam shell). For example, the rotation limiter 212 can be a cam 402 defining an angled or slanted section 404 on one side of the cam 402 and a substantially vertical, upright section 406 on an opposing side of the cam 402 (e.g., the upright section 406 can define a side of the cam 402 that extends substantially planar between a top end and a bottom end of the cam 402). The bottom end of the cam 402 can include a substantially flat end surface 408 between where the angled section 404 and the vertical section 406 meet or converge. The flat end surface 408 can define an endmost portion of the cam 402. The cam 402 can include at least one aperture 602 that can receive a rod 302. The aperture 602 can be disposed closer to the upright section 406 of the cam 402 than to the slanted section 404 such that the rod 302 provides additional support for the upright section 406. The cam 402 can include a block 410 (e.g., ledge or other similar component) configured to engage with a stopper 704 (FIG. 7B) of the pocket 304 such that the cam 402 does not fall out of the pocket 304. The rotation limiter 212 can be made for various materials. For example, the cam 402 can be formed of one or more types of plastic and the rod 302 can be formed of one or more types of metal (e.g., stainless steel). The rotation limiter 212 can be formed of various other materials. While the rod 302 is shown as a cylindrical rod, the rod 302 may include any insert or integrated component having various shapes including, but not limited to, a rod, a rectangular bar, an over-molded metal piece shaped similar to the outer cam 402, and/or various other shapes. In some implementations, the plastic outer cam 402 may facilitate protecting the finish of the hinge clamp 204 and/or the hinge mount body 202 as the cam 402 moves up and down relative to and/or up against the metal hinge mount body 202. In some implementations, the rod 302 may facilitate providing weight and/or structure for the cam 402 to limit rotation of the door 104 as described herein.

Referring to FIGS. 2-5, the vertical section 406 of the cam 402 can be disposed at a rear side of the pocket 304 with the configuration of the door 104 rotating in the direction of arrow 114. The rod 302 (e.g., a steel rod) can be disposed within the cam 402 at a location closer to the vertical section 406 than the angled section 404 to provide additional strength for the cam 402 at the vertical section 406. The substantially flat end surface 408 can provide additional strength for the cam 402 at the vertical section 406. With this configuration, the vertical section 406 of the cam 402 can prevent further rotation of the door 104 when a portion of the hinge clamp 204 and/or the door 104 contacts the vertical section 406 of the cam 402 and/or the flat end surface 408 of the cam 402, as described herein.

The angled section 404 of the cam 402 can be disposed at a front side of the pocket 304 with the configuration of the door 104 rotating in the direction of arrow 114. With this configuration, the angled section 404 of the cam 402 can allow rotation of the door 104, via the hinge clamp 204, when a portion of the hinge clamp 204 contacts the angled section 404 of the cam 402, as described herein. Additionally, a rotational force of the hinge clamp 204 engaging with the angled section 404 of the cam 402 can cause the cam 402 to extend out of or retract into the pocket 304 of the hinge mount body 202, as described herein.

The operation of the hinge assembly 108 will be described with reference to FIGS. 7A-11C, which show various states of rotation of the hinge clamp 204 (and the door 104, which is not depicted in these Figures, but could be disposed within the slot 206 of the hinge clamp 204).

FIG. 7A depicts a front perspective view of the hinge assembly 108 in a first state (e.g., rotational position), according to an example implementation. FIG. 7B is a front perspective sectional view of the hinge assembly 108 in the first state, according to an example implementation. In the first state, the hinge mount body 202 and the hinge clamp 204 are substantially aligned such that the door 104 (not depicted, but could be received within the slot 206) is in a closed state. For example, in this state, a longitudinal axis AMB of the hinge mount body 202 and a longitudinal axis AHC of the hinge clamp 204 can be substantially parallel. In this state, the rotation limiter 212 (e.g., the bottom flat surface 408 of the cam 402) can rest on a top surface 702 of the hinge clamp 204, since the rotation limiter 212 can freely move within the pocket 304 until the block 410 contacts the stopper 704 of the hinge mount body 202. The top surface 702 can be a topmost portion of the hinge clamp 204. For example, as depicted in at least FIG. 7B, when the flat surface 408 of the cam 402 rests on the top surface 702 of the hinge clamp 204, the block 410 of the cam 402 is disposed above the stopper 704, such that the cam 402 can move downward until the block 410 contacts the stopper 704 and the stopper 704 prevents movement of the cam 402.

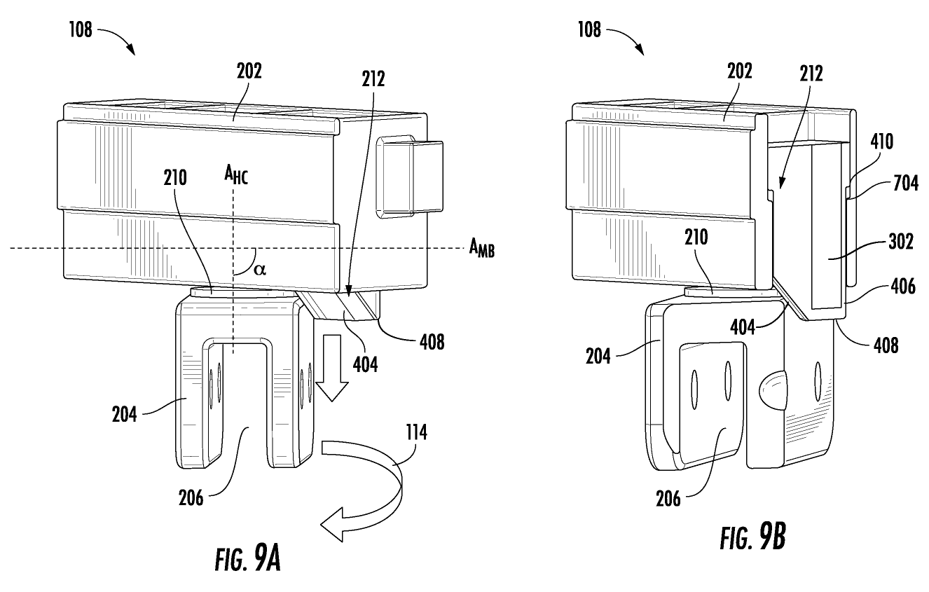

FIG. 8A is a front perspective view of the hinge assembly 108 in a second state (e.g., rotational position), according to an example implementation. FIG. 8B is a front perspective sectional view of the hinge assembly 108 in the second state, according to an example implementation. In the second state, the hinge clamp 204 begins to rotate relative to the hinge mount body 202 such that the door 104 (not depicted, but could be received within the slot 206) begins to open. For example, the hinge assembly 108 could begin to enter this state responsive to a user pushing or pulling the door 104 open. In this state, the bottom flat surface 408 of the cam 402 can be positioned at an edge portion of the hinge clamp 204. In this state, the angle α between the axis AMB of the hinge mount body 202 and the axis AHC of the hinge clamp 204 can be about 25° (e.g., in a range of 5° to 35°).

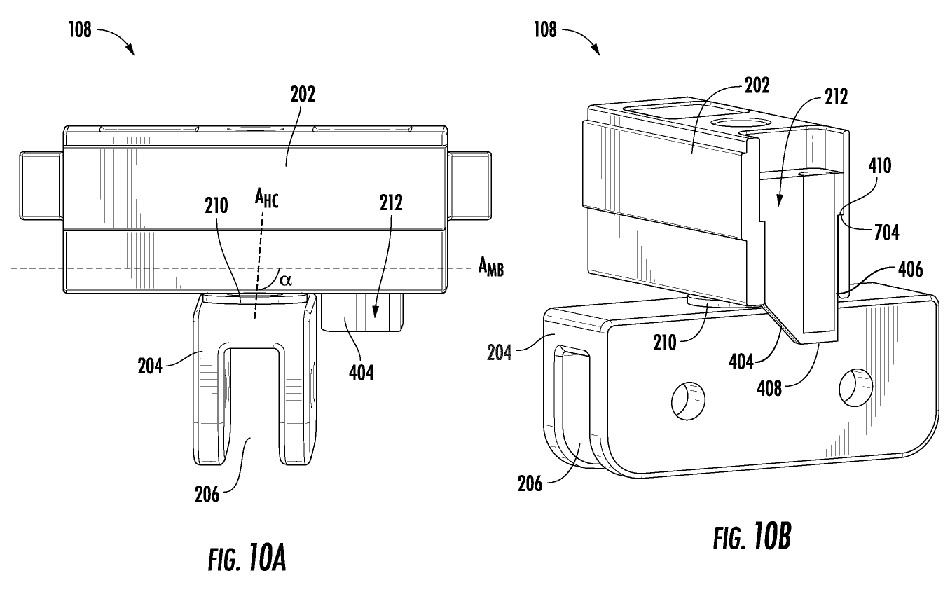

FIG. 9A is a front perspective view of the hinge assembly 108 in a third state (e.g., rotational position), according to an example implementation. FIG. 9B is a front perspective sectional view of the hinge assembly 108 in the third state, according to an example implementation. In the third state, the hinge clamp 204 continues to rotate relative to the hinge mount body 202 such that the door 104 (not depicted, but could be received within the slot 206) keeps opening. In this state, the angle α between the axis AMB of the hinge mount body 202 and the axis AHC of the hinge clamp 204 can be about 55° (e.g., in a range of 35° to 75°). In this state, the rotation limiter 212 (e.g., the bottom flat surface 408 of the cam 402) can begin to slide in a downward direction due to gravity, since the rotation limiter 212 can freely move or slide within the pocket 304 until the block 410 contacts the stopper 704 of the hinge mount body 202 and in this state, the hinge clamp 204 does not hold the rotation limiter 212 in place. For example, as depicted in at least FIG. 9B, when the flat surface 408 of the cam 402 no longer rests on the top surface 702 of the hinge clamp 204, the cam 402 can move in a downward direction until the block 410 contacts the stopper 704.

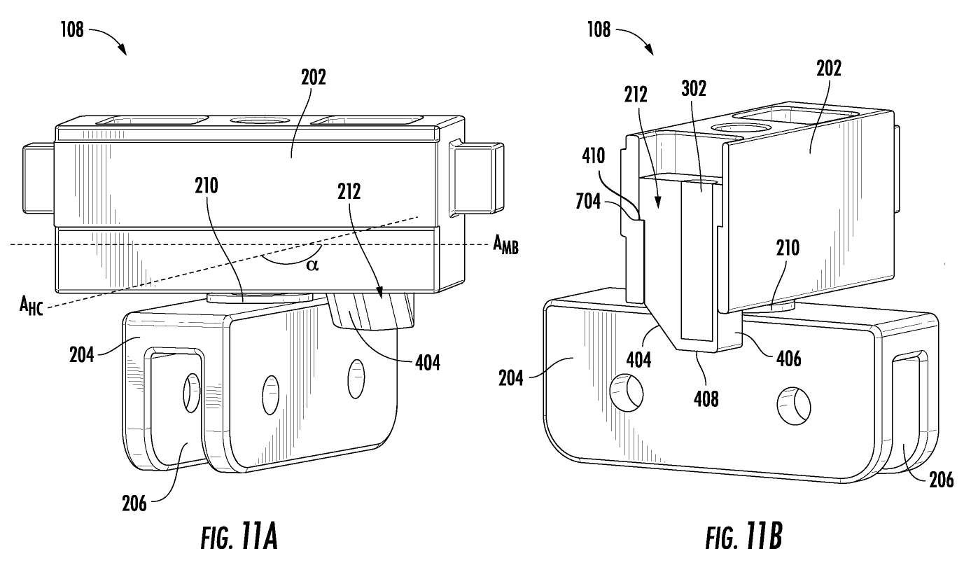

FIG. 10A is a front perspective view of the hinge assembly 108 in a fourth state (e.g., rotational position), according to an example implementation. FIG. 10B is a front perspective sectional view of the hinge assembly 108 in the fourth state, according to an example implementation. In the fourth state, the hinge clamp 204 continues to rotate relative to the hinge mount body 202 such that the door 104 (not depicted, but could be received within the slot 206) keeps opening. In this state, the angle α between the axis AMB of the hinge mount body 202 and the axis AHC of the hinge clamp 204 can be about 90° (e.g., in a range of 75° to 105°). In this state, the rotation limiter 212 can move in a downward direction due to gravity in a maximum extended position, since the rotation limiter 212 can freely move within the pocket 304 until the block 410 contacts the stopper 704 of the hinge mount body 202 and, in this state, the hinge clamp 204 does not hold the rotation limiter 212 in place. For example, as depicted in at least FIG. 10B, when the flat surface 408 of the cam 402 completely clears the hinge clamp 204, the cam 402 can slide in a downward direction until the block 410 contacts the stopper 704. Once the block 410 contacts the stopper 704, the cam 402 can remain in position in a fully extending position.

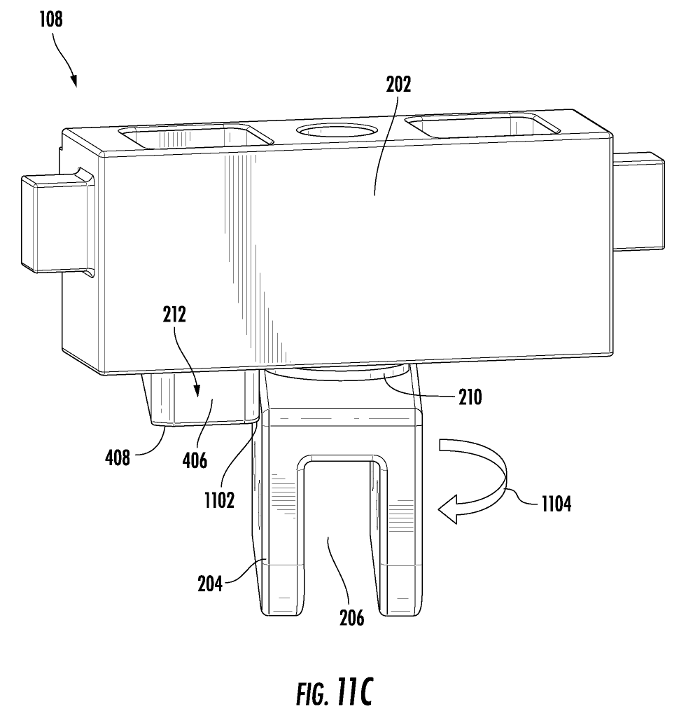

FIG. 11A is a front perspective view of the hinge assembly 108 of FIG. 2 in a fifth state (e.g., rotational position), according to an example implementation. FIG. 11B is a side perspective sectional view of the hinge assembly 108 in the fifth state, according to an example implementation. FIG. 11C is a rear perspective view of the hinge assembly 108 in the fifth state, according to an example implementation. In the fifth state, the hinge clamp 204 continues to rotate relative to the hinge mount body 202 such that the door 104 (not depicted, but could be received within the slot 206) is in a fully open state. In this state, the angle α between the axis AMB of the hinge mount body 202 and the axis AHC of the hinge clamp 204 can be about 110° (e.g., in a range of 105° to 125°). In this state, the rotation limiter 212 can be maintained in the fully extended position. At this angle of rotation, at least a portion of the hinge clamp 204 can engage with the vertical section 406 and/or the flat end surface 408 of the rotation limiter 212 (e.g., at contact area 1102 shown in FIG. 11C) such that the rotation limiter 212 prevents the hinge clamp 204 (and in turn, the door 104) from rotating/opening any further in that direction of rotation (e.g., in the direction of arrow 1104, the door opening direction). With the configuration of the vertical section 406, flat end surface 408, and/or the strength of the rod 302, the cam 402 can be strong enough to stop a force of the rotation of the hinge clamp 204. At this position, the door 104 may be fully open, such that the rotation limiter 212 prevents the door 104 from over-rotating and consequently causing a portion of the door 104 to contact the first door 102, or another portion of the system 100.

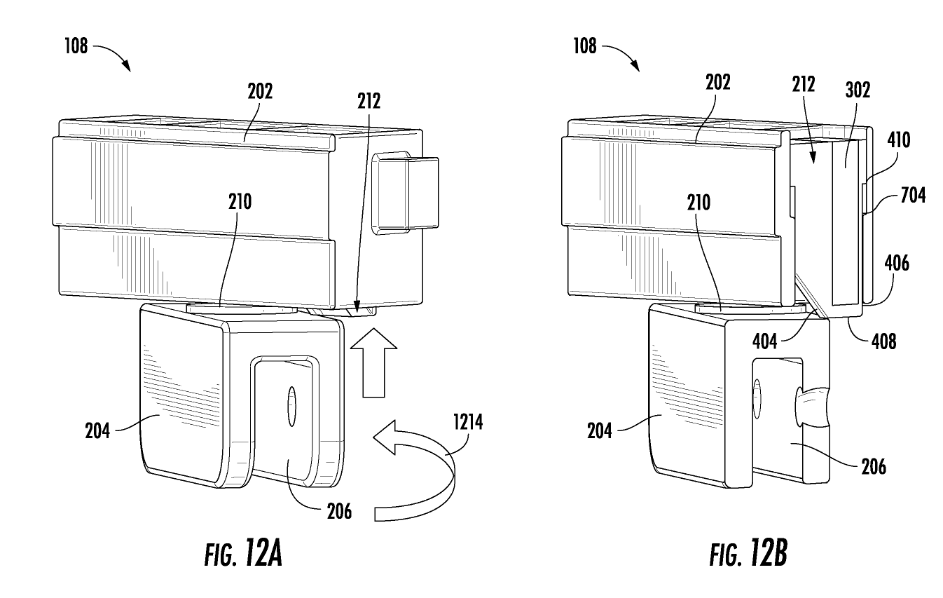

FIG. 12A is a front perspective view of the hinge assembly 108 of FIG. 2 in a sixth state (e.g., rotational position), according to an example implementation. FIG. 12B is a side perspective sectional view of the hinge assembly 108 in the sixth state, according to an example implementation. In the sixth state, the hinge clamp 204 can begin rotating in the opposite direction (e.g., a closing direction as depicted by arrow 1214) relative to the hinge mount body 202 such that the door 104 (not depicted, but could be received within the slot 206) begins to close relative to the system 100. In this state, at least a portion of the hinge clamp 204 can engage with the angled section 404 of the rotation limiter 212. The force of the rotating hinge clamp 204 to the angled section 404 of the rotation limiter 212 can cause the rotation limiter 212 (e.g., the cam 402) to move in an upwards direction back into the pocket 304 of the hinge mount body 202. When the hinge assembly 108 returns to back to the first state shown in FIGS. 8A and 8B, the cam 402 can be stored substantially in the pocket 304 and the door 104 can be in a closed state. For example, at about the third state of the hinge assembly 108 in the direction of the door 104 closing (e.g., when α is about 55°), the hinge clamp 204 can engage with the angled section 404 of the rotation limiter 212 to begin raising the rotation limiter 212 back into the pocket 304. At about the second state of the hinge assembly 108 in the direction of the door 104 closing (e.g., when α is about 25°), the hinge clamp 204 can engage with the angled section 404 of the rotation limiter 212 such that most of the rotation limiter 212 is pushed back into the pocket 304. With this configuration, the rotation limiter 212 can prevent over-rotation in an opening direction, but allow the door 104 to fully close in a closing direction. Moreover, the hinge mount body 202 can substantially conceal the rotation limiter 212 when the door 104 is in a closed state.

Advantageously, the rotation limiter 212 spaced further out from the center of rotation 306 that is shaped with a one-way cam 402 can prevent open-direction rotation of the door 104 at a certain opening width and/or angle α, but to still allow closed-direction rotation of the door 104. Moreover, the pocket 304 can receive most of the rotation limiter 212 responsive to the door 104 closing to be mostly concealed when the door 104 is fully closed. Additionally, the shape, size, and structure of the rotation limiter 212, including the rod 302, can facilitate preventing over-rotation of the door 104 even when the force of the moment of the door 104 is high. This provides benefits over conventional techniques, which do not limit rotation and can cause glass-to-glass contact when over-rotated.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the assembly as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A hinge assembly for a shower door, comprising:
a body including a pocket;
a hinge clamp rotatably coupled to the body, the hinge clamp configured to receive a portion of the shower door; and
a rotation limiter movably disposed in the pocket;
wherein the rotation limiter is configured to move relative to the pocket based on a rotational position of the hinge clamp relative to the body.

2. The hinge assembly of claim 1, wherein:
the hinge clamp is disposed beneath the body;
in a first rotational position of the hinge clamp relative to the body, the rotation limiter is substantially disposed within the pocket such that an end of the rotation limiter contacts a top of the hinge clamp; and
in a second rotational position of the hinge clamp relative to the body, the rotation limiter at least partially extends out of the pocket and is configured to contact a side of the hinge clamp to prevent rotation between the hinge clamp and the body in a first rotation direction and allow rotation between the hinge clamp and the body in a second rotation direction.

3. The hinge assembly of claim 2, wherein:
in the first rotational position, a relative rotational angle between a longitudinal axis of the body and a longitudinal axis of the hinge clamp is in a range of 5° to 35°; and
in the second rotational position, the relative rotational angle between the longitudinal axis of the body and the longitudinal axis of the hinge clamp is in a range of 105° to 125°.

4. The hinge assembly of claim 1, wherein:
the rotation limiter comprises a cam having a first side, a second side, a first end, and a second end;
the first side is planar between the first end and the second end;
the second side includes a slanted portion; and
the first side and the slanted portion converge to the second end.

5. The hinge assembly of claim 4, wherein:
the cam includes an aperture;
the aperture is disposed closer to the first side of the cam than the second side; and
the aperture is configured to receive a metal rod.

6. The hinge assembly of claim 1, wherein:
the rotation limiter includes a block;
the pocket includes a stopper;
in a first rotational position of the hinge clamp relative to the body, the block is disposed away from the stopper; and
in a second rotational position of the hinge clamp relative to the body, the block is configured to contact the stopper, thereby preventing movement between the rotation limiter and the pocket in at least one direction.

7. The hinge assembly of claim 1, wherein:
the pocket is a first pocket;
the body includes a second pocket; and
the first pocket and the second pocket are on opposing sides of a hinge coupling the hinge clamp with the body.

8. The hinge assembly of claim 1, wherein:
the pocket comprises a through hole defining a first open end and a second open end;
the pocket includes a stopper disposed between the first open end and the second open end; and
the rotation limiter is configured to slide within the pocket and engage with the stopper.

9. The hinge assembly of claim 1, wherein the body is configured to couple to a shower door frame such that the body and the hinge clamp allow relative rotation between the shower door and the shower door frame.

10. A shower door system, comprising:
a door; and
a hinge assembly configured to rotatably couple the door to a door frame, the hinge assembly including:
a body coupled to the door frame, the body including a pocket;
a hinge clamp rotatably coupled to the body, the hinge clamp configured to receive a portion of the door; and
a rotation limiter movably disposed in the pocket;
wherein the rotation limiter is configured to move relative to the pocket based on a rotational position of the hinge clamp relative to the body.

11. The shower door system of claim 10, wherein:
the hinge clamp is disposed beneath the body;
in a first rotational position of the hinge clamp relative to the body, the rotation limiter is substantially disposed within the pocket such that an end of the rotation limiter contacts a top of the hinge clamp; and
in a second rotational position of the hinge clamp relative to the body, the rotation limiter at least partially extends out of the pocket and is configured to contact a side of the hinge clamp to prevent rotation between the hinge clamp and the body in a first rotation direction and allow rotation between the hinge clamp and the body in a second rotation direction.

12. The shower door system of claim 11, wherein:
in the first rotational position, a relative rotational angle between a longitudinal axis of the body and a longitudinal axis of the hinge clamp is in a range of 5° to 35°; and
in the second rotational position, the relative rotational angle between the longitudinal axis of the body and the longitudinal axis of the hinge clamp is in a range of 105° to 125°.

13. The shower door system of claim 10, wherein:
the rotation limiter comprises a cam having a first side, a second side, a first end, and a second end;
the first side is planar between the first end and the second end;
the second side includes a slanted portion; and
the first side and the slanted portion converge to the second end.

14. The shower door system of claim 13, wherein:
the cam includes an aperture;
the aperture is disposed closer to the first side of the cam than the second side; and
the aperture is configured to receive a metal rod.

15. The shower door system of claim 10, wherein:
the rotation limiter includes a block;
the pocket includes a stopper;
in a first rotational position of the hinge clamp relative to the body, the block is disposed away from the stopper; and
in a second rotational position of the hinge clamp relative to the body, the block is configured to contact the stopper, thereby preventing movement between the rotation limiter and the pocket in at least one direction.

16. The shower door system of claim 10, wherein:
the pocket is a first pocket;
the body includes a second pocket; and
the first pocket and the second pocket are on opposing sides of a hinge coupling the hinge clamp with the body.

17. The shower door system of claim 10, wherein:
the pocket comprises a through hole defining a first open end and a second open end;
the pocket includes a stopper disposed between the first open end and the second open end; and
the rotation limiter is configured to slide within the pocket and engage with the stopper.

18. A shower door system, comprising:
a first door fixed to a door frame; and
a second door rotatably coupled to the door frame by a hinge assembly, the hinge assembly including:
a body coupled to the door frame, the body including a pocket;
a hinge clamp rotatably coupled to the body, the hinge clamp configured to receive a portion of the second door; and
a rotation limiter movably disposed in the pocket;
wherein, in a first rotational position of the second door, the rotation limiter is configured to move relative to the pocket to prevent the second door from rotating in a first direction; and
wherein, in a second rotational position of the second door, the rotation limiter is configured to move relative to the pocket to allow the second door to rotate in the first direction.

19. The shower door system of claim 18, wherein:
the second door is configured to at least partially overlap the first door; and
in the first rotational position, the rotation limiter is configured to contact a side of the hinge clamp to prevent the second door from contacting the first door.

20. The shower door system of claim 18, wherein in the second rotational position, an endmost portion of the rotation limiter is configured to rest on a topmost portion of the hinge clamp.
